(19) United States
(12) Patent Application Publication
(10) Pub. No.: US 2017/0373881 A1
(43) Pub. Date: Dec. 28, 2017

(54) SYSTEMS AND METHODS FOR CONTROLLING ISOCHRONOUS DATA STREAMS

(71) Applicant: QUALCOMM Incorporated, San Diego, CA (US)

(72) Inventors: Andy Yu, San Diego, CA (US); Andrew Cheung, Escondido, CA (US); Ameya Kulkarni, San Diego, CA (US)

(21) Appl. No.: 15/631,807

(22) Filed: Jun. 23, 2017

Related U.S. Application Data
(60) Provisional application No. 62/355,166, filed on Jun. 27, 2016.
(60) Provisional application No. 62/517,247, filed on Jun. 9, 2017.

(51) Int. Cl. H04L 12/40; H04L 12/931; H04L 12/28

(52) U.S. Cl. CPC H04L 12/40058; H04L 49/608; H04L 12/40117; H04L 2012/2849

(57) ABSTRACT

Systems and methods for controlling isochronous data streams are disclosed. Particular aspects of the present disclosure are designed to be used with almost any isochronous data stream, but are well-suited for use with the Universal Serial Bus (USB) protocol. Further, aspects of the present disclosure are flexible to accommodate existing configuration possibilities within the USB protocol as well as accommodate proposed future changes in the USB protocol. The flexibility of the systems and methods is provided by calculating: (1) drift between a USB host system time and the application and (2) drift between the USB host system and a USB device clock. Based on these two drift calculations, a time stamp may be synthesized to program a next delivery schedule. Using this time stamp, jitter correction can take place and uniformly-sized packets may be assembled to pass to an application processor.

### PRIORITY CLAIMS

The present application claims priority to U.S. Patent Provisional Application Ser. No. 62/355,166 filed on Jun. 27, 2016 and entitled “PROGRAMMABLE RATE-MATCHED DATA RATE OUTPUT REGULATOR FOR ISOCHRONOUS DATA STREAMS,” the contents of which is incorporated herein by reference in its entirety.

The present application also claims priority to U.S. Patent Provisional Application Ser. No. 62/517,247 filed on Jun. 9, 2017 and entitled “ISOCHRONOUS DATA STREAM CONTROL SYSTEMS AND METHODS,” the contents of which is incorporated herein by reference in its entirety.

### BACKGROUND

### I. Field of the Disclosure

The technology of the disclosure relates generally to handling arbitrary data streams on a data bus.

### II. Background

Computing devices have become ubiquitous in contemporaneous living. The popularity of computing devices has exploded in part because of the ever increasing functionality available on the computing devices. Concurrent with the increase in functionality has been an increase in the numbers and types of supplemental devices that may be associated with the computing devices. In some cases the supplemental devices may be integrated into the computing devices, such as the integration of a camera into a smart phone. In other cases, the supplemental devices may be peripherals, such as audio headsets that are coupled to a computing device through some form of external interface. In both cases various protocols have arisen to allow applications running on the computing device to interact with the supplemental devices as needed.

One popular protocol is the Universal Serial Bus (USB) protocol. USB exists in various flavors including full speed (FS), high speed (HS), and super speed (SS). Additionally, USB allows for various clock synchronization schemes between a host and a peripheral device. In particular, USB contemplates synchronizing to a clock from the peripheral device (referred to as asynchronous), synchronizing to a clock from the host (referred to as synchronous), and sharing clock synchronization responsibilities between the host and the peripheral device (referred to as adaptive). While the various flavors and clock synchronization schemes allow for design flexibility to increase the number of devices using the USB protocol, the myriad options make some design decisions more difficult.

Such design decisions are further complicated when audio and/or video streams are being transmitted through a USB interface. Because of the universal nature of the USB form factor, a USB host is expected to be able to accommodate both audio/video capture from and audio/video playback to a peripheral. In particular, the USB host is expected to be able to accommodate different speeds, different clock synchronization schemes, different sampling rates, and variably-sized data. Conventional systems place the burden on such accommodation at the application layer, which requires substantial buffering and complicated algorithms on the part of applications in the application layer. Additionally, there are current proposals to increase service intervals, which may impose additional burdens on the application processor that handles the application layer. Accordingly, there is a need for a way to provide a USB compatible system that allows for greater flexibility in handling variable data streams both those currently implemented and that has the flexibility to handle differing input parameters.

### SUMMARY OF THE DISCLOSURE

Aspects disclosed in the detailed description include systems and methods for controlling isochronous data streams. Particular aspects of the present disclosure are designed to be used with almost any isochronous data stream, but are well-suited for use with the Universal Serial Bus (USB) protocol. Further, aspects of the present disclosure are flexible to accommodate existing configuration possibilities within the USB protocol as well as accommodate proposed future changes in the USB protocol. The flexibility of the systems and methods is provided by calculating: (1) drift between a USB host system time and the application and (2) drift between the USB host system and a USB device clock. Based on these two drift calculations, a time stamp may be synthesized to program a next delivery schedule. Using this time stamp, jitter correction can take place and uniformly-sized packets may be assembled to pass to an application processor. The use of such uniformly-sized packets may eliminate the need for buffers in an application layer, which may improve user experience when a data stream is an audio data stream.

In this regard in one aspect, a method for controlling communication in a USB system is disclosed. The method includes receiving variably-sized packets at a first processor having a USB driver. The method also includes assembling uniformly-sized packets at the first processor. The method also includes passing the uniformly-sized packets to a second processor for use by applications at an application layer in a protocol stack.

In another aspect, a host is disclosed. The host includes an application processor. The host also includes USB hardware. The host also includes an audio digital signal processor (ADSP). The ADSP is configured to receive variably-sized packets at the ADSP through the USB hardware. The ADSP is also configured to assemble uniformly-sized packets at the ADSP. The ADSP is also configured to pass the uniformly-sized packets to the application processor for use by applications at an application layer in a protocol stack.

In another aspect, a host is disclosed. The host includes an application layer. The host also includes USB hardware. The host also includes a system on a chip (SoC) including a plurality of processors. The plurality of processors is configured to receive variably-sized packets at a first processor. The plurality of processors is also configured to assemble uniformly-sized packets at the first processor. The plurality of processors is also configured to pass the uniformly-sized packets to a second processor for use by applications at an application layer in a protocol stack.

In another aspect, a method for detecting drift in a USB system is disclosed. The method includes determining that a fractional sampling rate is used on a USB bus between an audio peripheral and a host. The method also includes determining a first fractional remainder associated with the fractional sampling rate over a service interval. Based on the first fractional remainder, the method also includes calculating a whole number corresponding to a number of intervals required to have no fractional remainder. The method also includes checking drift each whole number of intervals.

In another aspect, a processor is disclosed. The processor includes an input. The processor also includes a control system. The control system is configured to determine that a fractional sampling rate is used on a USB bus between an audio peripheral and a host. The control system is also configured to determine a first fractional remainder associated with the fractional sampling rate over a service interval. Based on the first fractional remainder, the control system is also configured to calculate a whole number corresponding to a number of intervals required to have no fractional remainder. The control system is also configured to check drift each whole number of intervals.

In another aspect, a method to synthesize a time stamp is disclosed. The method includes receiving a run command from a data delivery handler. The method also includes summing an output from a high resolution timer and a computed absolute time stamp.

In another aspect, a processor is disclosed. The processor includes an audio data buffer. The processor also includes a USB audio client (UAC). The UAC is configured to receive variably-sized packets. The UAC is also configured to assemble uniformly-sized packets. The UAC is also configured to pass the uniformly-sized packets to a second processor for use by applications at an application layer in a protocol stack.

### BRIEF DESCRIPTION OF THE FIGURES

FIG. 1 is a simplified perspective view of a mobile communication device with a remote audio peripheral coupled through a Universal Serial Bus (USB) cable and connector according to an exemplary aspect of the present disclosure;

FIG. 2 is a block diagram of a conventional audio flow from a USB peripheral to an application layer within a processor;

FIG. 3 is a block diagram of an audio flow within a USB system according to exemplary aspects of the present disclosure;

FIGS. 4A and 4B show two USB systems with alternate placements of a data regulator of the present disclosure;

FIG. 5 is a block diagram of a data regulator;

FIG. 6 is a signal flow diagram showing how packet size is calculated and how packets are passed to an application layer;

FIG. 7 is a block diagram of an in-band drift reporting process from a microphone to a USB host;

FIG. 8 is a block diagram of an out-of-band drift reporting process from a microphone to a USB host;

FIG. 9 is a block diagram of an in-band drift reporting process from a microphone to a host and how the host uses same for playback to a speaker;

FIG. 10 is a block diagram of an out-of-band drift reporting process from a microphone to a host and how the host uses same for playback to a speaker; and

FIG. 11 is a block diagram of an exemplary processor-based system that can include the USB system of FIG. 3.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for controlling isochronous data streams. Particular aspects of the present disclosure are designed to be used with almost any isochronous data stream, but are well-suited for use with the Universal Serial Bus (USB) protocol. Further, aspects of the present disclosure are flexible to accommodate existing configuration possibilities within the USB protocol as well as accommodate proposed future changes in the USB protocol. The flexibility of the systems and methods is provided by calculating: (1) drift between a USB host system time and the application and (2) drift between the USB host system and a USB device clock. Based on these two drift calculations, a time stamp may be synthesized to program a next delivery schedule. Using this time stamp, jitter correction can take place and uniformly-sized packets may be assembled to pass to an application processor. The use of such uniformly-sized packets may eliminate the need for buffers in an application layer, which may improve user experience when a data stream is an audio data stream.

Before addressing particular aspects of the present disclosure, a brief overview of an exemplary system which may implement the systems and methods for controlling isochronous data streams is disclosed. As noted above, while applicable to various isochronous data streams, exemplary aspects are particularly applicable to USB audio streams. Thus, the exemplary system is a USB digital audio system.

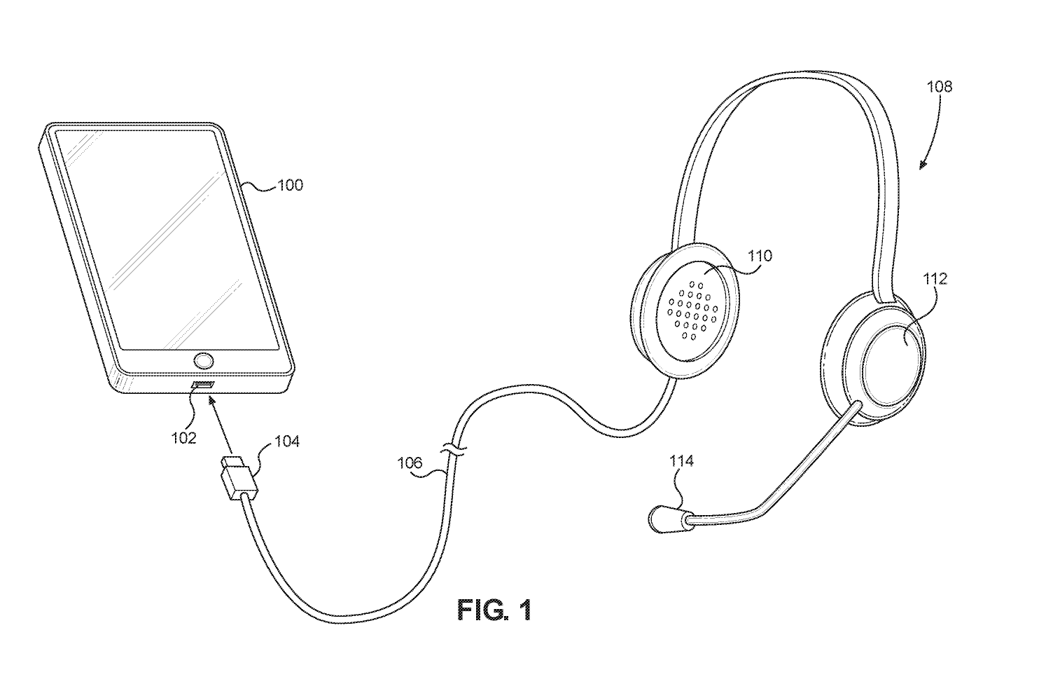

In this regard, FIG. 1 is a simplified perspective view of a mobile communication device 100 with a USB Type-C receptacle 102 configured to couple to a USB Type-C connector 104 on a USB cable 106. At a distal end of the USB cable 106 is a digital audio headset 108 having plural speakers 110 in headphones 112 and a microphone 114. Digital audio signals may pass between the mobile communication device 100 and the digital audio headset 108 through the USB cable 106. Audio from the microphone 114 may be unevenly distributed in a time domain as speech patterns are rarely periodic. Likewise, the mobile communication device 100 does not know a priori what data speed the digital audio headset 108 supports nor does the mobile communication device 100 know a priori what synchronization format the digital audio headset 108 uses.

While exemplary aspects of the present disclosure are well suited for audio environments such as the digital audio headset 108 of FIG. 1, the present disclosure is not so limited, and may be used with an audio/video signal that passes between a computing device, such as the mobile communication device 100, and a virtual reality headset having a display, speakers, and a microphone (or a display having speakers and a microphone). Likewise, while a USB Type-C cable is disclosed above, the present disclosure is readily usable with other versions of USB. In fact, being able to handle any of the USB speeds (e.g., full speed (FS), super speed (SS), high speed (HS)) is one of the advantages of the present disclosure.

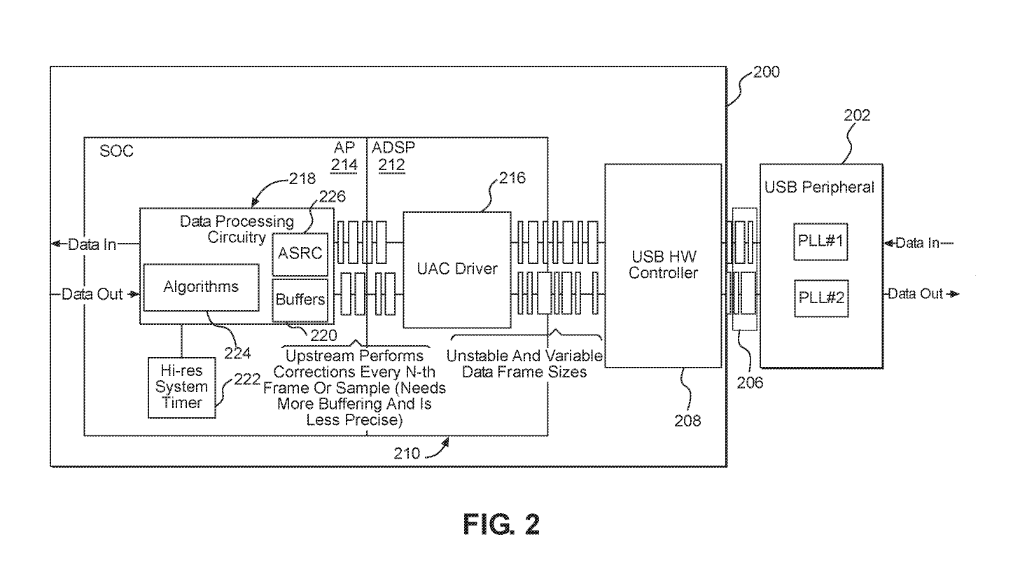

FIG. 2 provides a simplified block diagram of how audio (and perhaps video) data is handled in a mobile communication device 200 that does not implement aspects of the present disclosure. The mobile communication device 200 may be coupled to a USB peripheral 202, such as a digital audio headset. The USB peripheral 202 may support asynchronous, synchronous, adaptive, or mixed clock synchronization modes and may include one or more phase locked loops (PLLs, two illustrated) or delay locked loops (DLLs, not illustrated). The USB peripheral 202 may receive data (referenced as Data IN), such as through a microphone (sometimes referred to as capture), as well as output data (referenced as Data OUT), such as through a speaker in a headphone (sometimes referred to as playback). The data is passed to and from the mobile communication device 200, such as through a USB cable 206, and through an appropriate receptacle (not illustrated in FIG. 2) to a USB hardware controller 208 within the mobile communication device 200. The USB hardware (sometimes referenced as HW in the drawings) controller 208 is communicatively connected to a system on a chip (SoC) 210. The SoC 210 may include an audio digital signal processor (ADSP) 212 and an application processor (referred to in the drawings as AP) 214. The ADSP 212 may include a USB Audio Client (UAC) driver 216. The data from the USB peripheral 202 is received at the USB hardware controller 208 and passed to the SoC 210. Note that the data from the USB peripheral 202 is jittery and includes variable data frame sizes (symbolically illustrated by the variously-sized boxes between the USB hardware controller 208 and the UAC driver 216). Further variability may occur if the one or more PLLs of the USB peripheral 202 run fast or slow. Still further variability may occur, because in the USB protocol, there is no requirement that there be a fixed number of samples within a frame. While such variability is part of what contributes to the flexibility and appeal of the USB protocol, such variability is generally difficult to handle in audio processing. When the USB hardware controller 208 has data in its internal buffers (not shown), the USB hardware controller 208 generates an interrupt for the UAC driver 216. The USB hardware controller 208 does not have a time stamping function. The UAC driver 216 receives the interrupt, drains the buffer of the USB hardware controller 208, and attempts to provide a constant amount of data to the application processor 214. When there is fractional audio sampling, such as the common sampling rate of 44.1 kilohertz (kHz), which is fractional relative to one millisecond (corresponding to a common USB bus transfer speed of 1000 Hz), the UAC driver 216 will send data with 44 samples in nine out of ten packets and one packet with 45 samples. Data processing circuitry 218 in the application processor 214 uses its buffers 220 in conjunction with a high resolution system timer 222 to smooth out the variability before the data is provided to application layer algorithms 224. An asynchronous sample rate converter (ASRC) 226 may assist in this process of correcting drift and a jittery cluster of samples over a time duration. This arrangement places a burden on the application processor 214 and requires additional programming for the application layer algorithms 224. Note that while the ADSP 212 and the application processor 214 are described as being separate processors, both devices may be integrated into a single integrated circuit (IC). While not illustrated, a hardware direct memory access (DMA) controller may generate a data interrupt, and a hardware latched time stamp from the high resolution system timer 222 gets stored in a hardware register. This time stamp is not readily associated with the USB packets and thus is not readily available to assist in drift detection.

Exemplary aspects of the present disclosure provide error free drift detection from which jitter correction may be applied and from which a synthesized time stamp may be calculated. Using this synthesized time stamp, a next delivery schedule may be calculated which is used to drain the buffers. Further, by repositioning the calculation outside the application processor, uniform data frame sizes may be provided to the application processor, which in turn may improve audio quality and potentially provide power savings opportunities. One of the benefits of the present disclosure is the flexibility of the disclosure to accommodate any form of clock synchronization approach (asynchronous, synchronous, or adaptive) between the host and the device as well as various data speeds, different sampling rates, variably-sized data, different USB speeds (HS, FS, SS), and differing service intervals. While the present disclosure may be implemented strictly in hardware, the flexibility of the present disclosure is improved through the use of software, where the variables are more readily adjusted to accommodate any configuration. Before exploring the particulars of the system of the present disclosure and the various signaling that may be used to implement aspects of the present disclosure, an overview of the equations used to create the flexibility are presented.

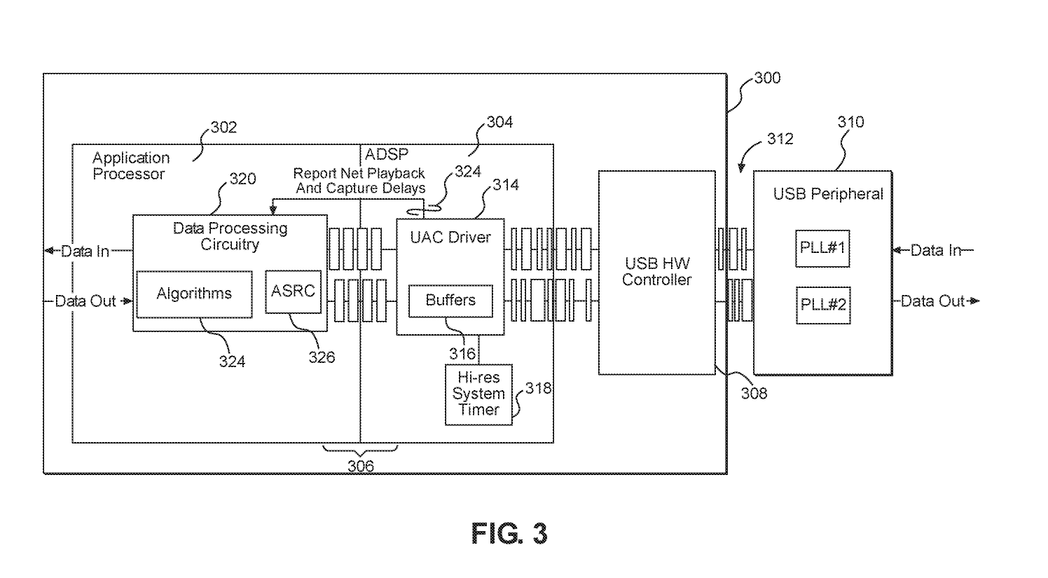

The following section is math intensive and preserved for the interested reader, but may not be critical to understand exemplary aspects of the present disclosure. For the readers who prefer not to let math clutter their understanding of the disclosure, the discussion of exemplary aspects begins again below with reference to FIG. 3.

The basic drift compensated rate matched audio buffer delivery model that is used by the host may be expressed as:

ticksₙₑₓₜ=ticks_{reference}+ticks_{offset}+D₁+D₂ . . . +D_{M} (Eq. 1)

In Eq. 1, ticksₙₑₓₜ (also referred to as “Tnext”) is the synthesized time stamp that is effectively used to program the next delivery schedule. ticks_{reference} (also referred to as “Tref”) is the timestamp of the first synthesized timestamp. Ticks_{offset} (also referred to as “Toffset”) is the delta from the ticks_{reference} used for the delivery of buffers and also serves as timing of the picking up of buffers for playback and capture. In Eq. 1, each Dᵢ represents the total drift between a device clock and a USB time reference. In most situations, there are only three clocks to consider, the USB host clock, the audio application clock, and the USB device clock. The USB host clock serves as the system time reference for both of the other two clocks, and thus, Eq. 1 will typically simplify to:

ticksₙₑₓₜ=ticks_{reference} ticks_{offset} D_{app-usb}−D_{device-usb} (Eq. 2)

Eq. 2 works for both audio capture and audio playback paths. D_{app-usb} is the time difference between the audio application clock and the USB host clock. D_{device-usb} is how fast the USB device clock is going with reference to the USB host clock. Together these values give the net system drift (i.e., is the audio sample moving faster or slower). For the audio capture path, when D_{device-usb} is positive, the device is delivering audio samples faster than the USB host is clearing them. When D_{app-usb} is positive the audio application is retrieving audio samples faster than the USB host is delivering them. On the audio playback path, when D_{app-usb} is positive, the audio application is delivering audio samples faster than the USB host is clearing them. When D_{device-usb} is positive, the device is retrieving audio samples faster than the USB host is delivering them. This value is passed to an asynchronous sample rate converter (ASRC) to synthesize and/or interpolate audio allowing the ASRC to know how much to correct.

The drift D_{device-usb} for the capture and playback paths may be determined explicitly or implicitly. The drift is obtained based the direction of the data flow (i.e., device-to-host (usually capture) or host-to-device (usually playback)). The source of the drift information is dependent on what the USB advertises and which isochronous synchronization mode is selected for a USB endpoint pair by the high level operating system (HLOS). In fact, there are twenty combinations of isochronous synchronization modes between the capture and playback paths.

The source of drift information is summarized in Table 1 below. D_{device-usb} is abbreviated D_{device} in Table 1.

TABLE 1
Source of Drift Information

| | | | Async | Async | |
|---|---|---|---|---|---|
| In/Out | Sync | Adaptive | Implicit | Explicit | None |
| Sync | In: Eq 12 | In: Eq 12 | N/A | In: Eq 12 | In: Eq 12 |
| | Out: D_{device} = 0 | Out: D_{device} = 0 | | Out: Eq 6 | Out: None |
| Adaptive | In: Eq 12 | In: Eq 12 | N/A | In: Eq 12 | In: Eq 12 |
| | Out: D_{device} = 0 | Out: D_{device} = 0 | | Out: Eq 6 | Out None |
| Async | In: Eq 12 | In: Eq 12 | In: Eq 12 | In: Eq 12 | In: Eq 12 |
| | Out: D_{device} = 0 | Out: D_{device} = 0 | Out: D_{device} = | Out: Eq 6 | Out: None |
| | | | D_{device, in} | | |
| None | In: None | In: None | In: Eq 12 | In: None | N/A |
| | Out: D_{device} = 0 | Out: D_{device} = 0 | Out: D_{device} = | Out: Eq 6 | |
| | | | D_{devicee, in} | | |

Table 1 assumes that the audio application clock is in phase with the USB host clock (D_{app-usb}=0). This assumption causes all synchronous and adaptive playback (Out) paths to have Out: D_{device}=0.

Exemplary aspects of the present disclosure provide techniques to detect drift for essentially any variation of sampling frequency, sampling interval, sample size, bus speed, clock synchronization mode, or the like. This flexibility is achieved through generic equations that accommodate these variable inputs and allow for the appropriate drift detection.

It should be appreciated that the quality, environment, and manufacturing precision all affect one asynchronous clock's ability to keep time compared to another asynchronous clock in the system. There are systems where there are multiple clocks along the capture path and multiple clocks on the playback path. The net drift for a path is the sum of the time differentials between each subsystem clock along the path. The present disclosure illustrates that by measuring drift at the appropriate frequency, error free drift detection is enabled and needless measurements are avoided, which may allow power savings.

Audio streaming in a USB system adds difficulty in that such audio streaming is expected to use the isochronous transfer mode. It is a real-time dedicated bandwidth mode with no error checking or retries. Audio samples are bundled in the form of an audio packet and an audio packet may be sent once every (micro)frame. Each such frame is either 125 μs or 1 ms depending on whether a HS or FS USB transfer mode is selected by the physical layer. The USB protocol supports sending such frames in bursts for power savings and for handling large network latencies. The number of frames per service interval is described by 2^{binterval-1} where binterval is currently a value between one and 16. Discussions have been made amongst the governing body for the USB protocol for expanding this number. The number of frames per service interval is fixed, but the number of audio samples sent per burst can be variable.

A factor that has been considered as pertinent to evaluating drift includes keeping the accumulated drift using the source unit of measurement. Conversions from one unit to another unit generally involve a division operation which may introduce rounding or truncation errors. Accumulation of such truncation errors may lead to a divergence in the interpretation of time between the host and the device. By keeping the accumulation in the source unit of measurement, any truncation error is temporary and should be seen by the system as insignificant jitter.

A further factor is the maximum tolerable system jitter. A reasonable tolerable system jitter is less than one audio sample of accuracy to avoid being interpreted as real drift by the audio system. Thus, the tolerable system jitter may be a function of the audio sampling frequency. If the tolerable jitter is sufficiently small, hardware assistance may be necessary as a pure software implementation may not be able to react fast enough to service an interrupt to timestamp an event.

Given these considerations, Eq. 6 may be derived when considering a USB audio device's instantaneous frequency feedbacks as a clock source. In such instance, F_{f} is the average number of audio samples per frame that the USB device reports to the USB host. An instantaneous frequency F_{f} is reported to the host in the FS USB transfer mode on every:

Period_{FS}=2^{10-bRefresh} frames (Eq. 3)

Or in the HS USB transfer mode on every:

Period_{HS}=2^{(binterval-1} microframes (Eq. 4)

The instantaneous drift is thus

Δdrift=F_{fk}−F_{fk-1} (Eq. 5)

and is computed when the host receives a feedback

Ticks_{conv}(D)=(D*1000)/fₛ*19.2 MHz (Eq. 6)

Where fₛ is the sampling frequency. Note that 19.2 MHz is the speed of one exemplary high resolution system timer. If the high resolution system timer has a different speed, a different value should be substituted herein, which turns Eq. 6 into the following generic equation.

Ticks_{conv}(D)=(D*1000)/fₛ*fₜᵢₘₑᵣ (Eq. 6A)

There are challenges in recovering a clock from a USB 2.0 signal resulting from the definitional equivalence of the virtual packet being one virtual frame. Accordingly, a solution to recover a clock from a non-linear data stream is required. Such solution follows, with the assumption that each clock crystal has at least 500 ppm of accuracy. The number of samples per virtual frame is defined as

numSamplesPerVirtualFrame=fₛ/fₜ*2^{(binterval-1)} (Eq. 7)

Where fₛ is the sampling frequency, fₜ is the service interval frequency, and binterval is as defined above. For ease of notation, the numSamplesPerVirtualFrame may be abbreviated as NSPVF

Additionally, an alignment multiplier is needed, and defined as follows:

$$alignmentMultiplier = \frac{1000000}{GCD ( MOD ( NSPVF * 1000000 , 1000000 ) , 1000000 )} \qquad ( Eq . 8 )$$

where 1000000 is arbitrarily chosen as a very large base 10 value to increase fractional precision. From Eq. 7 and 8, an expected number of samples may be calculated as follows:

expectedNumSamples=NSPVF*alignmentMultiplier (Eq. 9)

The alignmentMultiplier represents the least number of virtual frames needed by the host before a stable drift determination is possible. The expectedNumSamples is the number of samples expected to be received. The NSPVF is an intermediate variable for visual clarity and not a floating point. For each alignmentMultiplier number of virtual frames received, the Adrift is computed by:

Δdrift=numSamplesReceived−expectedNumSamples (Eq. 10)

Thus, the net drift from the beginning of the audio session is computed by:

D=D_{net drift}+Δdrift (Eq. 11)

The conversion of D audio samples to system timer (sometimes referred to as Qtimer) ticks is:

Ticks_{conv}(D)=D_{net drift}/fₛ*19.2 MHz (Eq. 12)

Again, note that 19.2 MHz is the speed of the high resolution system timer. If the high resolution system timer has a different value, then such different value should be substituted herein, resulting in:

Ticks_{conv}(D)=D/fₛ*fₜᵢₘₑᵣ (Eq. 12A)

With the drift information and the clock detection information outlined above, rate matching may be done. With rate matching, uniform sample sizes may be created and sent to the application processor as outlined below. However, before addressing the uniform sample sizes, more math is presented to explain the rate matching. In particular, this helps define how to calculate ticks_{offset}.

Remember, absent drift

ticksₑₓₜ=ticks_{reference}+ticks_{offset} (Eq. 13)

Where ticks_{offset} is defined as

$${ticks}_{offset} = \frac{{f}_{t}}{1 khz} * \frac{{f}_{d}}{{f}_{s}} * i \qquad ( Eq . 14 )$$

Where f_{d} is the delivery frequency and i increments on every tickₙₑₓₜ and wraps around when i=fₛ to avoid i from overflowing. At the wrap around point, ticks_{referenee}=ticksₑₓₜ and then i=0.

Armed with the math set forth above, exemplary aspects of the present disclosure are now set forth. In this regard, FIG. 3 is a simplified block diagram of how audio (and perhaps video) is handled in a mobile communication device 300 that implements exemplary aspects of the present disclosure.

The mobile communication device 300 includes an application processor 302 and an ADSP 304. In an exemplary aspect, the application processor 302 and the ADSP 304 may be in a single SoC 306. Likewise, while described as conceptually distinct processors, these processors may be part of a single host processor. Still further, while ascribed specific functions such as “application processor” or “ADSP,” it should be appreciated that other processors that are traditionally not referred to by such appellations may still implement comparable functionality without departing from the scope of the present disclosure. The application processor 302 may communicate with a USB hardware controller 308, which communicates with a USB peripheral 310, such as a headset, through a USB interface 312, which may include USB receptacles, USB connectors, and a USB cable.

As with the USB peripheral 202 of FIG. 2, the USB peripheral 310 may support asynchronous, synchronous, adaptive, or mixed clock synchronization modes and may include one or more PLLs (two illustrated) or DLLs (not illustrated). The USB peripheral 310 may receive data (referenced as Data In), such as through a microphone (as noted above, sometimes referred to as capture), as well as output data (referenced as Data Out), such as through a speaker in a headphone (as noted above, sometimes referred to as playback). The data is passed to and from the mobile communication device 300 through the USB interface 312.

The ADSP 304 may include a UAC driver 314. The UAC driver 314 may use a host controller interface (HCI) (not illustrated) to communicate with the USB hardware controller 308. In conventional systems, there is no HCI in the UAC driver 314, because the ADSP 304 does not communicate with the USB hardware controller 308. However, exemplary aspects of the present disclosure allow for communication between the USB hardware controller 308 and the ADSP 304. Accordingly, an HCI may be provided to effectuate such communication. The UAC driver 314 receives unstable and variably-sized data frames from the USB hardware controller 308.

Exemplary aspects of the present disclosure add one or more buffers 316 to the UAC driver 314 as well as couple a high resolution system timer 318 to the UAC driver 314, which allows the UAC driver 314 to pass stable, precise, and fixed data frame sizes to data processing circuitry 320 in the application processor 302 (or other processor that handles applications). Still further, the UAC driver 314 may provide net playback and capture delays to the data processing circuitry 320 through a signal 322. By providing uniform data frames to the data processing circuitry 320, application layer algorithms 324 do not have to buffer the data as heavily or perform the corrections associated with the data processing circuitry 218 of FIG. 2. Even though the application layer algorithms 324 receive uniform data frames, the application processor 302 may include an ASRC 326 that may assist in processing the signal 322 to act on drift correction information and/or jitter issues. Again, note that the application processor 302 may be merged with the ADSP 304 as a single microprocessor or may be provided different names by different vendors.

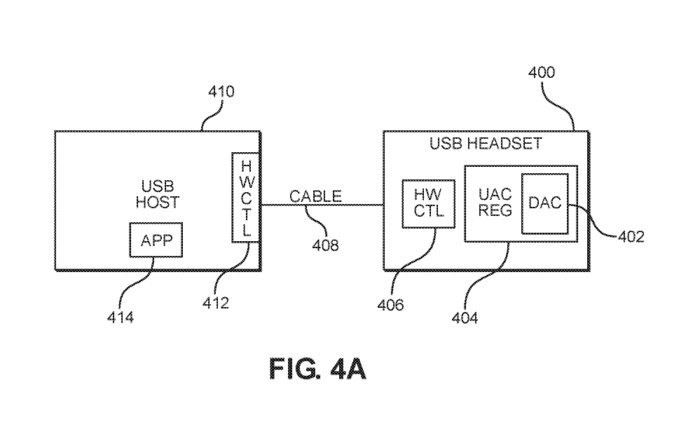

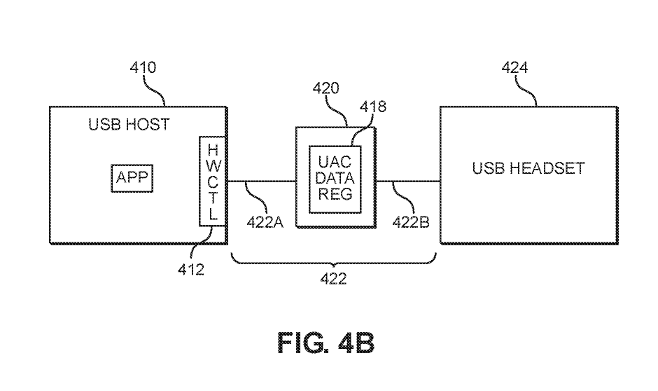

While FIG. 3 contemplates positioning the UAC driver 314 in the ADSP 304, it should be appreciated that other positions are also possible as illustrated in FIGS. 4A and 4B.

In this regard, FIG. 4A illustrates a headset 400 (or other USB peripheral) with a digital audio converter (DAC) 402 that captures data from a microphone or the like and provides the data to a UAC data regulator (UAC data reg) 404. The UAC reg 404 makes the packet size uniform and provides packets to a hardware controller 406, which in turn passes the packets over a cable 408 to a USB host 410. The USB host 410 receives the packets with a host hardware controller 412. Applications 414 (labeled APP in the Figures) in the application layer (not specifically illustrated) receive the uniform packets and process them as is well understood. In such an arrangement, the USB host 410 may operate similarly to the USB host of FIG. 2, but benefits from the uniform packets that the headset 400 sends to the USB host 410. The increased circuitry in the headset 400 may increase the cost of the headset 400, but may provide benefits to legacy USB hosts.

In FIG. 4B, the USB host 410 remains unchanged, but instead of placing a data regulator in the headset 400, a UAC data regulator 418 is provided in an intermediate device 420, such as a dongle 420. The dongle 420 can be on a host side 422A or a peripheral side 422B of a cable 422. That is, the cable 422 may extend between the dongle 420 and a headset 424 with the dongle 420 inserted into a USB receptacle of the USB host 410, or the cable 422 may extend between the USB host 410 and the dongle 420 with the dongle 420 inserted into the USB receptacle of the headset 424. As still another possibility (illustrated), the dongle may be in the cable 422 and the cable 422 inserts into the respective receptacles of the USB host 410 and the headset 424.

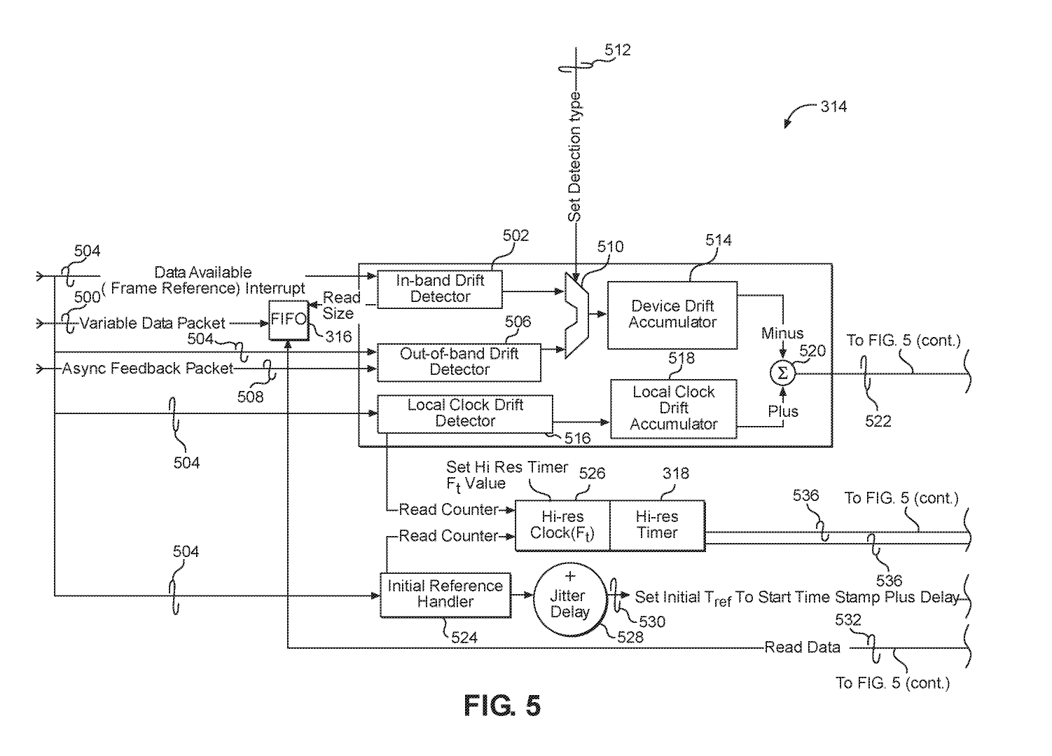

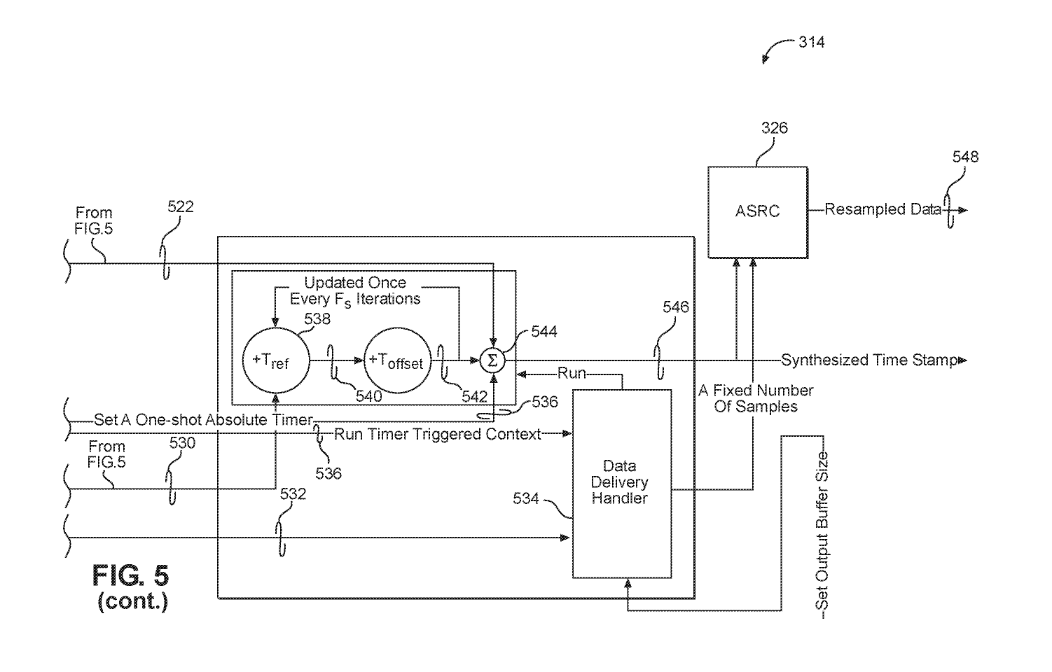

FIG. 5 is a block diagram of a data regulator that may be implemented inside the UAC driver 314 of FIG. 3. The buffer 316 (also referred to as a FIFO in FIG. 5), receives a variably-sized data packet 500. An in-band drift detector 502 reads the size of the data packet 500 in the buffer 316 when it receives a data available interrupt signal 504. Alternatively, an out-of-band drift detector 506 receives an asynchronous feedback packet signal 508 and the data available interrupt signal 504. One of the detectors 502 or 506 is read by a multiplexer 510. The multiplexer 510 selects between outputs of the detectors 502 and 506 by a set detection type signal 512. The multiplexer 510 outputs a signal to a device drift accumulator 514. Concurrently, the data available interrupt signal 504 is provided to a local clock drift detector 516, which provides a signal to a local clock drift accumulator 518. A summer 520 subtracts the device drift accumulator 514 output (D_{device-usb}) from the output of the local clock drift accumulator 518 (D_{app-usb}) and outputs a signal 522. The signal 522 corresponds to D_{app-usb}−D_{device-usb}.

With continued reference to FIG. 5, the data available interrupt signal 504 is also provided to an initial reference handler 524. The initial reference handler 524 outputs a read counter to a high resolution clock function 526. The high resolution clock function 526 also receives a read counter from the local clock drift detector 516. The high resolution clock function 526 may also receive a set Hi-res Timer Fₜ value which would allow the clock value to be varied. Note that it is unlikely that this value changes in mid-operation, but can be set at system initialization or the like. The high resolution clock function 526 interoperates with the high resolution system timer 318. The initial reference handler 524 also is added to a jitter delay element 528 and used to set an initial Tref to start a time stamp plus delay signal 530.

The buffer 316 outputs a data signal 532 (labeled “read data”) to a data delivery handler 534, which also receives an output 536 of the high resolution system timer 318. The data delivery handler 534 may also receive a set output buffer size command (perhaps from the ASRC 326) indicating what size buffers the ASRC expects to process. The signal 530 is provided to a summer 538 which adds Tref thereto and generates an intermediate signal 540, to which is added Toffset, to generate a signal 542, which is passed to a summer 544 (which essentially performs either Eq. 6 or Eq 12 as appropriate). The summer 544 adds the signal 542, the signal 522, and the output 536 to generate a synthesized time stamp 546 (essentially Eq. 2). The data delivery handler 534 outputs a run command for the summer 544 and provides a fixed number of samples to the ASRC 326. The ASRC 326 also receives the synthesized time stamp 546 and outputs resampled data 548. While not specifically illustrated, a set sampling frequency command may also be received to assist in calculations as noted above.

In an exemplary aspect, this data regulator is implemented as software. In another exemplary aspect, this data regulator may be implemented in hardware.

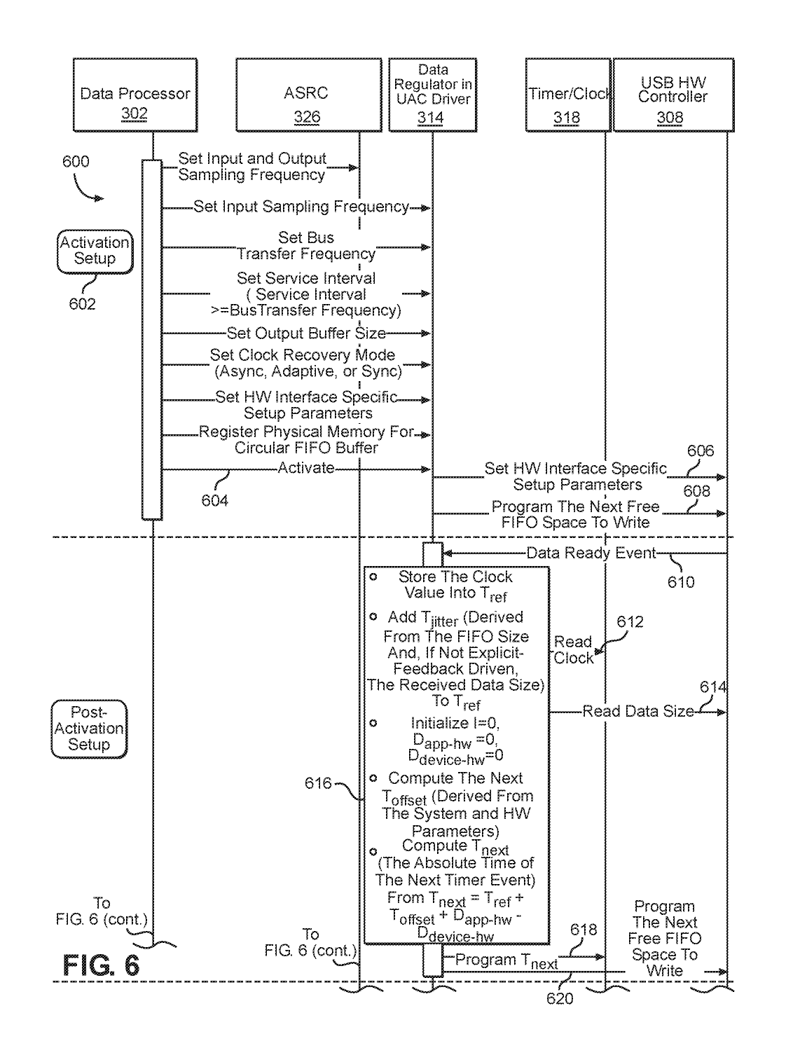

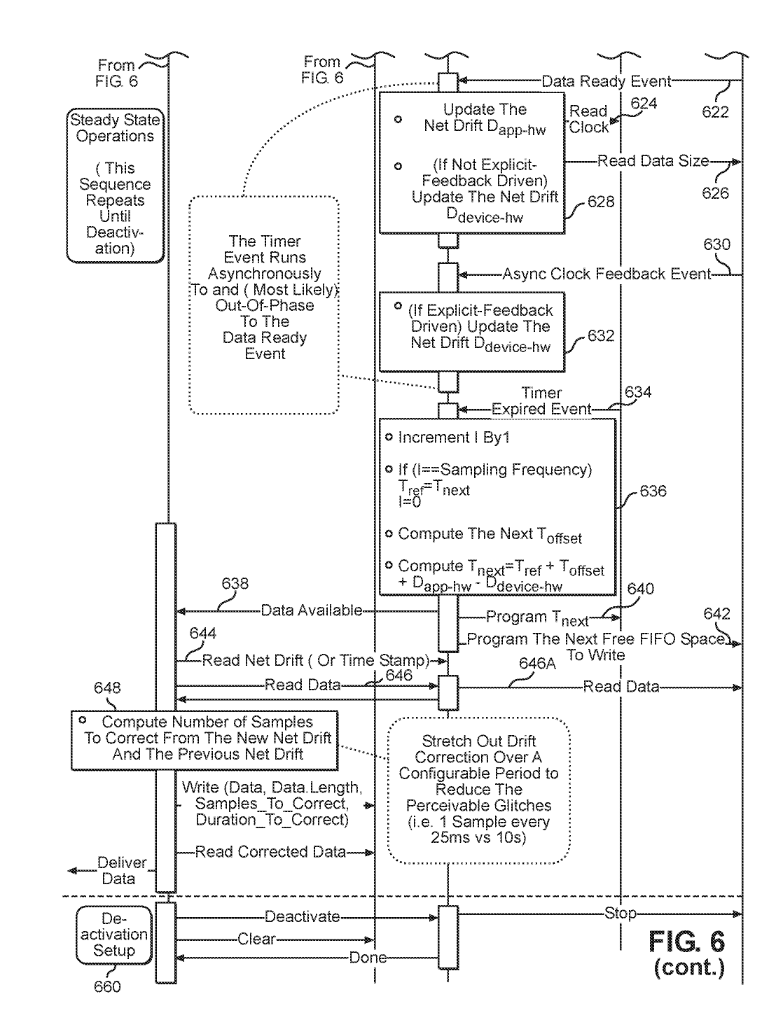

FIG. 6 is a signal flow diagram representing signals and processes that may occur when an application in a data processor wants to use the UAC driver 314 of FIG. 3. Initially, an application provides setup information in an activation setup stage. The setup information may include sampling rate, bus transfer frequency, buffer size, clock recovery mode, and the like. This setup information is provided to a data rate regulator (see FIG. 5) of the UAC driver 314. The data rate regulator calculates how to deliver data from the USB hardware controller 308 accurately and stably (without jitter) at the rate that has been requested. The process for this calculation is explained above. The timer/clock element in this diagram is the high resolution system timer 318 of FIG. 3, but other timers could also be used.

FIG. 6 is a signal flow diagram 600 representing signals and processes that may occur when an application in a data processor such as the application processor 302 wants to use the UAC driver 314. Initially, the application provides the setup information in the activation setup stage (block 602). The application processor 302 sets the input and output sampling frequency at the ASRC 326, and sends the input sampling rate frequency, the bus transfer frequency, service interval (which is greater than or equal to the bus transfer frequency), output buffer size, clock recovery mode (asynchronous, adaptive, or synchronous), any hardware interface specific setup parameters, and register any physical memory for the buffer(s) 316 to the UAC driver 314 and particularly to a data regulator in the UAC driver 314. Finally an activate command (signal 604) is sent to the data regulator. The data regulator passes the hardware interface specific setup parameters to the USB hardware controller 308 (signal 606) and programs the next free buffer space to write (signal 608). The USB hardware controller 308 sends a data ready event signal 610 to the data regulator. This signal 610 causes the data regulator to read the high resolution system timer 318 (signal 612), read the data size (signal 614) from the USB hardware controller 308, and perform a series of actions including: store the clock value into Tref, add Tjitter (derived from the buffer size and if not explicitly feedback driven, the received data size) to Tref, initialize i=0; D_{device-usb}=0; D_{app-usb}=0; and compute the next Toffset; compute Tnext (Eq. 2) (see generally block 616). The data regulator then programs Tnext for the high resolution system timer 318 (signal 618) and programs the next free buffer space to write (signal 620).

With continued reference to FIG. 6, the system enters a steady state and the data regulator receives a next data ready event (signal 622) from the USB hardware controller 308, which triggers a read clock signal 624 and a read data size signal 626 which allows the data regulator to update the net drift (D_{device-usb} and D_{app-usb}) (see generally block 628).

At some point, the USB hardware controller 308 may send an asynchronous clock feedback event (signal 630) to the data regulator, which causes the data regulator to update D_{device-usb} (see generally block 632).

At some other time, the high resolution system timer 318 may send a timer expired event signal 634 to the data regulator. Responsive to this signal 634, the data regulator may increment i by one, and if i equals the sampling frequency, set Tref to Tnext and i=0; compute the next Toffset; and compute Eq. 2 (see generally block 636). The data regulator may send a data available signal 638 to the application processor 302, and program Tnext (signal 640), and program the next free buffer space to write (signal 642). The application processor 302 reads the net drift or time stamp from the data regulator (signal 644) and reads data from the buffer(s) 316 in the UAC driver 314 (signal 646) and/or the USB hardware controller 308 (signal 646A).

The application processor 302 computes the number of samples to correct from the new net drift and the previous net drift (block 648), and writes data into its file system, such as by using a write command with data, data length, samples to correct, and duration to correct variables. Note that the data may be voice packets. If necessary, the drift correction may be stretched out over a configurable period to reduce perceivable glitches. However, even with the stretched-out period, it is expected that such correction takes place on the order of 25 ms instead of 10 seconds as is sometimes used in conventional systems. The process then deactivates (block 660).

Note further that additional aspects of the present disclosure provide techniques to provide error free drift detection and support future planned power saving initiatives. In this regard, it should be appreciated that fractional sampling rates, such as the relatively common 44.1 kHz, lend themselves to false detections of drift because of the phase mismatch between accumulators at the peripheral device and accumulators at the host. In contrast to signaling protocols that include time stamps to assist in drift detection, the USB protocol does not include time stamps from the peripheral device to the host. Rather, the host only receives packetized USB data. Inside each USB packet, the amount of data is variable. The problem with the fractional sampling rate and unknown packet size has been well documented in the industry. The usual solution is to time average the samples over a long period, such as ten minutes, and then perform correction of the drift. The long delay in assembling the time average of samples results in latency before correction is applied. Until the correction is applied, the user may experience a degraded audio experience. Likewise, the granularity of the correction may not be appropriate for instantaneous or random drift events.

Exemplary aspects of the present disclosure allow for error free drift detection. This is best explained through the use of an example. Assuming that the sampling frequency (Fs) is 44.1 kHz and that the USB bus transfer speed is 1000 Hz (i.e., 1 sample per millisecond), and a binterval (samples per packet) of 11, the host would expect to receive 45158.4 samples per interval. The fractional sample cannot be sent under USB rules. The peripheral device accumulator begins when the samples are transmitted to the host, but the host accumulator is delayed until after reception, so the accumulators are out of phase. At the second interval the peripheral accumulator is 90316.8. Again, it is the fractional sample which shows up as drift relative to the host accumulator. Over time, without external drift, this drift will toggle between 1 and 0, but may on occasion cause a correction to be made that is not needed.

Instead of time averaging the drift as in previous solutions, exemplary aspects of the present disclosure evaluate the fractional remainder and find the number of intervals required to arrive at a whole number. In the present example, if the fractional remainder is 0.4, then the number of intervals required to arrive at a whole number is 5. (0.4=2/5, the denominator is 5, so five intervals). The UAC driver 314 may check the accumulator at a boundary determined by the number of intervals so calculated. Thus, in this example, the UAC driver 314 checks the drift every five intervals. The phantom drift caused by the fractional sampling rate is not present, so if drift is detected, that is real drift for which a correction must be made (i.e., interpolation or decimation or the like). Further, by ignoring drift in the intermediate samples, calculations may be forgone, which may result in power savings.

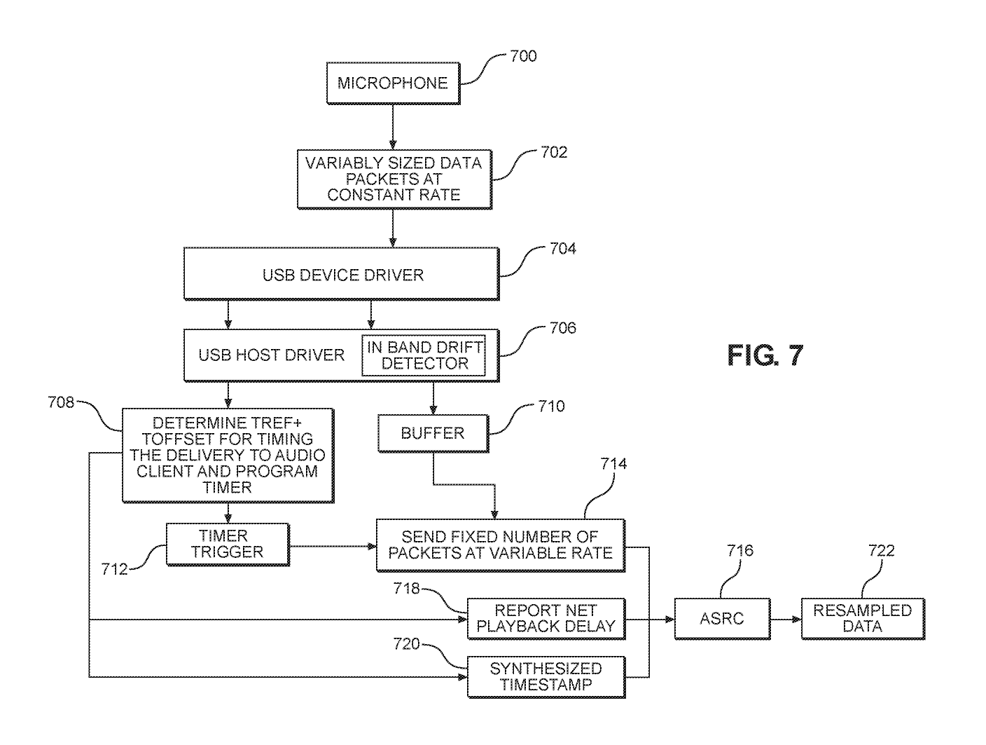

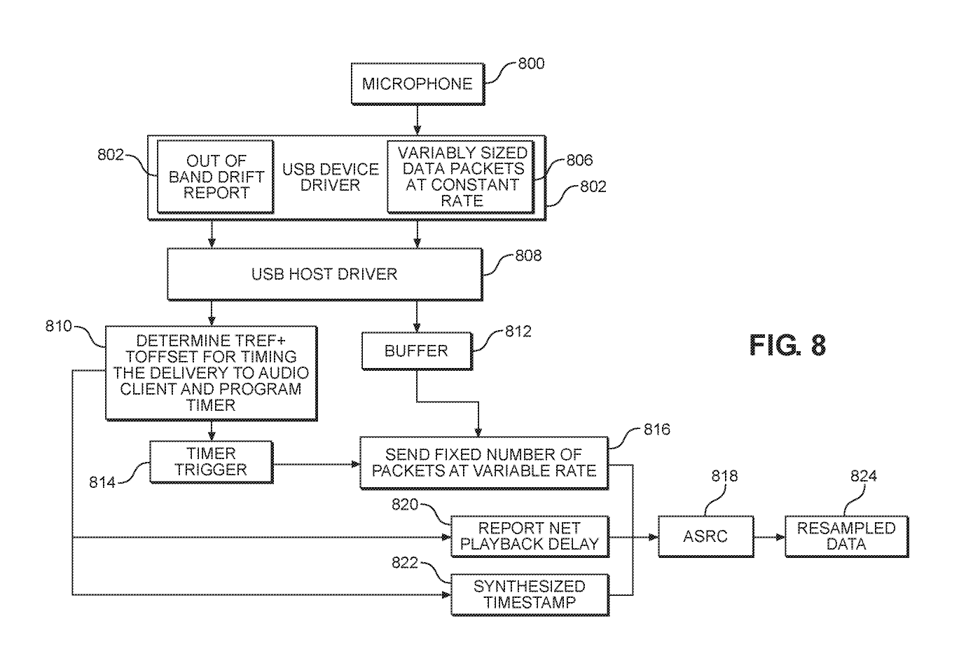

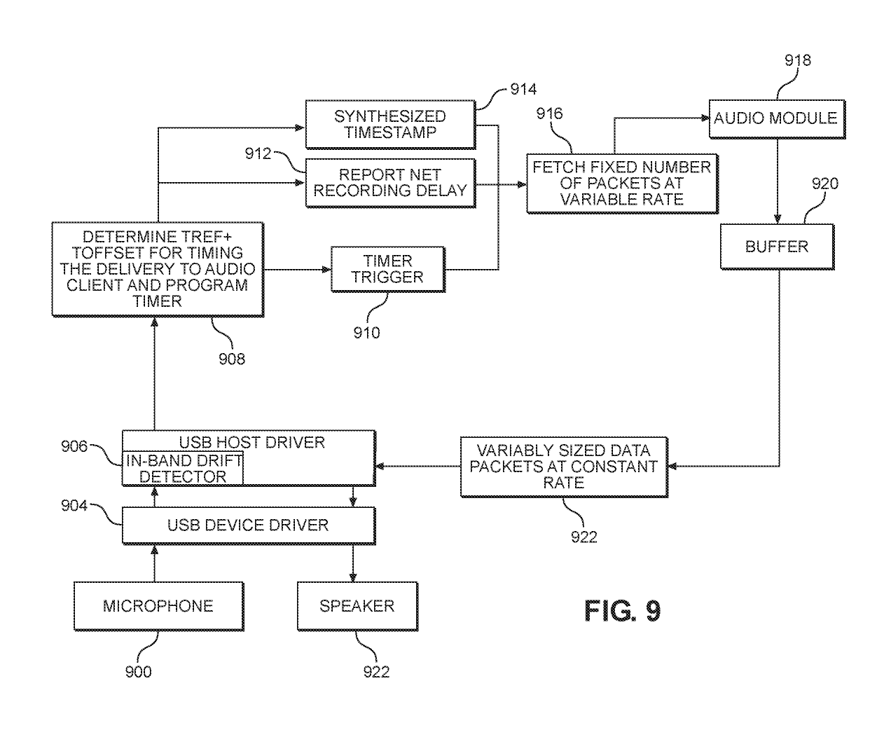

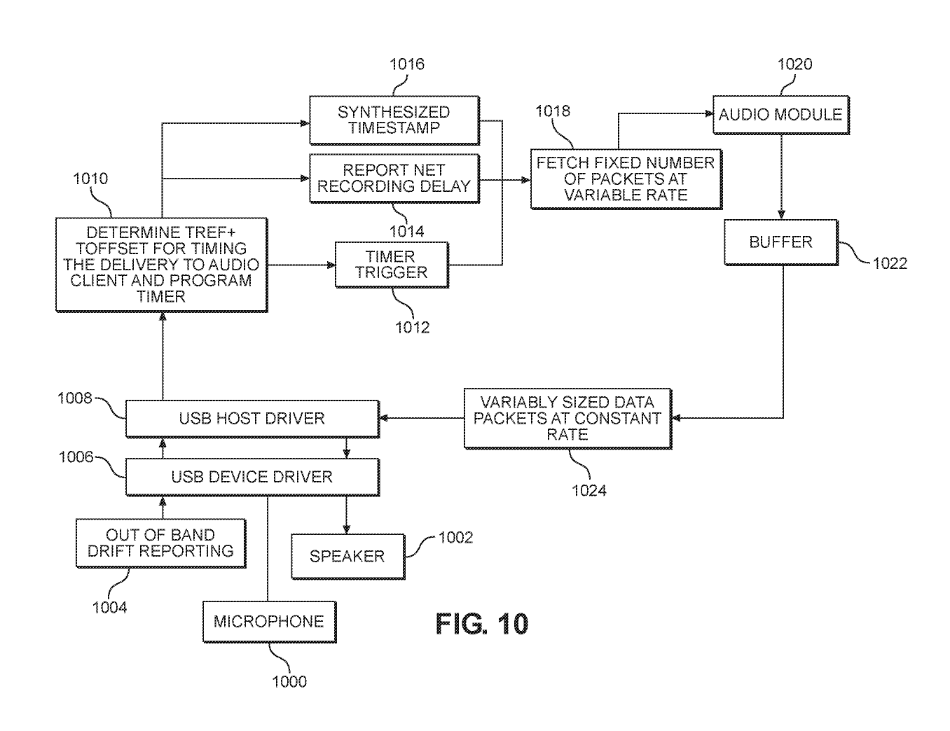

The USB protocol contemplates two forms of drift reporting. The first is an implicit drift detection where in-bound signals are examined and compared to known values to determine a drift. The second is an explicit out-of-band signaling of drift sent by the peripheral device to the host, where the peripheral device compares samples received to an expected number of samples and reports back any drift between these two values. The USB protocol is silent as to how implicit drift detection is performed, and the USB protocol is also silent on how the host may correct for any drift detected (either implicitly or explicitly). The present disclosure has set forth several equations above and a process for handling drift detection and correction thereof. FIGS. 7-10 illustrate the two possible drift reporting possibilities for both audio sources (FIGS. 7 and 8) and audio sinks (FIGS. 9 and 10) and the correction process. In particular, FIG. 7 illustrates an in-band drift reporting process for an audio source, namely, a microphone 700. Data is captured by the microphone 700 and passed in variably-sized data packets (block 702) at a constant rate through a USB device driver 704 to a USB host driver 706 in a USB host. The USB host driver 706 derives the drift information implicitly from data from the microphone 700 and the extracted drift information is used to determine Tref+Toffset for timing the delivery to the audio client and program timer (block 708) while the data is stored in a buffer 710. The formula for determining Tref+Toffset is set forth above. At a timer trigger 712 based on the output of block 708, a fixed number of packets at a variable rate (block 714) are sent to an ASRC 716 from the buffer 710. Concurrently, the drift information is used to report net playback delay (block 718) and generate a synthesized timestamp (block 720). The ASRC 716 outputs resampled data (block 722). While the fixed number of packets is, in fact, fixed, varying the rate allows the drift to be corrected. That is, packet delivery may be accelerated to correct one drift, or slowed down to correct drift in the other direction.

Similarly, FIG. 8 is substantially similar but reflects an out-of-band drift reporting process for a microphone 800. In particular, the drift detection is performed by a USB device driver 802 based on output of the microphone 800. The USB device driver 802 then outputs an out-of-band drift report (block 804) and also sends variably-sized data packets at a constant rate (block 806). Both the drift information and the data are provided to a USB host driver 808 in a USB host. The drift information is used to determine Tref+Toffset for timing the delivery to an audio client and program timer (block 810) using the equations set forth above while the data is stored in a buffer 812. At a timer trigger 814 based on the output of block 810, the buffer 812 sends a fixed number of packets at a variable rate (block 816) to an ASRC 818. Concurrently, the drift information is used to report net playback delay (block 820) and generate a synthesized timestamp (block 822). The ASRC 818 outputs resampled data (block 824). Again, use of the variable rate allows for drift correction.

In contrast, FIGS. 9 and 10 explore the impact of drift on the playback path. In this regard, FIG. 9 illustrates an in-band drift reporting process. A microphone 900 may act as the microphone 700 of FIG. 7, but of greater interest is speaker 902. The speaker 902 receives data from a USB device driver 904. The USB device driver 904 receives data from a USB host driver 906. The USB host driver 906 compares the data coming into the USB host driver 906 to the USB reference as described above to determine drift information. This drift information is used to determine Tref+Toffset for timing the delivery to an audio client and program timer (block 908) using the equations described above. This determination is used to help generate a timer trigger (block 910), report net recording delay (block 912), and create a synthesized timestamp (block 914). At the timer trigger (block 910), a fixed number of packets at a variable rate are fetched (block 916) and provided to an audio module 918, which buffers the packets in a buffer 920. The buffer 920 releases variably-sized data packets at a constant rate (block 922) and provides them to the USB host driver 906, which passes them to the speaker 902 through the USB device driver 904. The use of the variably-sized data packets allows for drift to be corrected. Correction of drift in speaker direction can be inferred from drift detected at the USB host driver 906 via an in-band drift detector, provided both the microphone 900 and the speaker 902 are clocked via the same source.

Similarly, FIG. 10 illustrates an out-of-band drift reporting process. A microphone 1000 may act as the microphone 800 of FIG. 8 describe above. Of more interest is speaker 1002. The speaker 1002 passes out-of-band drift information and data (block 1004) to a USB device driver 1006. The USB device driver 1006 receives data from a USB host driver 1008 and likewise passes the out-of-band drift information to the USB host driver 1008. This drift information is used to determine Tref+Toffset for timing the delivery to an audio client and program timer (block 1010). This determination is used to help generate a timer trigger (block 1012), report net recording delay (block 1014), and create a synthesized timestamp (block 1016). At the timer trigger (block 1012), a fixed number of packets at a variable rate are fetched (block 1018) and provided to an audio module 1020, which buffers the packets in a buffer 1022. The buffer 1022 releases variably-sized data packets at a constant rate (block 1024) and provides them to the USB host driver 1008, which passes them to the speaker 1002 through the USB device driver 1006. Again, the use of the variably-sized data packets allows for drift correction.

As noted above, exemplary aspects also allow for future contemplated power savings. This possibility is enabled by the generic (sometimes referred to as agnostic) algorithms used to handle the variable data and sampling rates. That is, in the equations above, the equations start with the agnostic fₛ, as the sampling rate and fₜ as the bus transfer speed (which already contemplates FS, SS, and HS). By using these agnostic values in the application layer algorithms 324, other new sampling rates or other non-standard sampling rates are accommodated. The agnostic approach allows proper estimation of a DLL. It should be appreciated that an increase in binterval (the number of samples per packet) increases the size of the packet and also increases the time that it takes to fill the buffer(s) 316. Since the application processor 302 is idle while the buffer(s) 316 is being filled, the application processor 302 may be put into a low-power mode or sleep mode. The longer it takes to fill the buffer(s) 316 (i.e., a larger number of samples per packet), the longer the application processor 302 may be in the sleep mode. The longer the application processor 302 is in the sleep mode, the more power is saved. Thus, there is pressure in the industry to increase the number of samples per packet. By having a generic binterval in the application layer algorithms 324, exemplary aspects of the present disclosure may accept larger binterval values in the audio device descriptor and thus accommodate any future changes in the number of samples per packet and thus allow for future power savings.

The systems and methods for controlling isochronous data streams according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

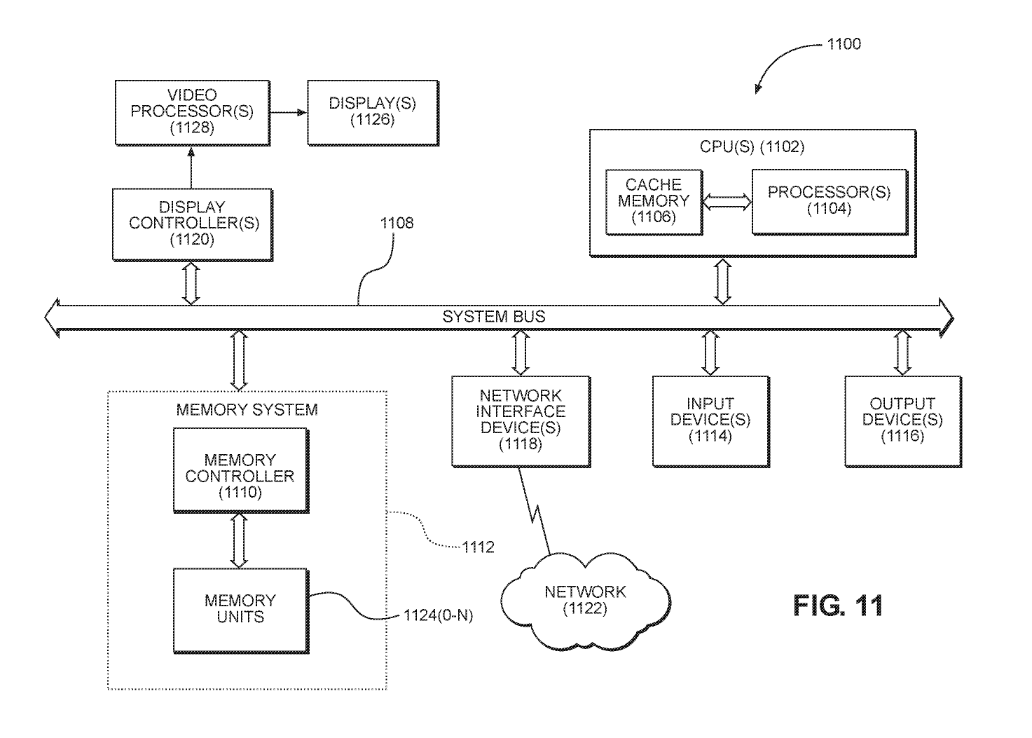

In this regard, FIG. 11 illustrates an example of a processor-based system 1100 that can employ a USB system that performs the drift detection, rate matching and uniform packet assembly described herein. In this example, the processor-based system 1100 includes one or more central processing units (CPUs) 1102, each including one or more processors 1104. The CPU(s) 1102 may have cache memory 1106 coupled to the processor(s) 1104 for rapid access to temporarily stored data. The CPU(s) 1102 is coupled to a system bus 1108 and can intercouple master and slave devices included in the processor-based system 1100. As is well known, the CPU(s) 1102 communicates with these other devices by exchanging address, control, and data information over the system bus 1108. For example, the CPU(s) 1102 can communicate bus transaction requests to a memory controller 1110 as an example of a slave device. Although not illustrated in FIG. 11, multiple system buses 1108 could be provided, wherein each system bus 1108 constitutes a different fabric.

Other master and slave devices can be connected to the system bus 1108. As illustrated in FIG. 11, these devices can include a memory system 1112, one or more input devices 1114, one or more output devices 1116, one or more network interface devices 1118, and one or more display controllers 1120, as examples. The input device(s) 1114 can include any type of input device, including, but not limited to, input keys, switches, voice processors, etc. The output device(s) 1116 can include any type of output device, including, but not limited to, audio, video, other visual indicators, etc. The network interface device(s) 1118 can be any devices configured to allow exchange of data to and from a network 1122. The network 1122 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 1118 can be configured to support any type of communications protocol desired. The memory system 1112 can include one or more memory units 1124(0-N).

The CPU(s) 1102 may also be configured to access the display controller(s) 1120 over the system bus 1108 to control information sent to one or more displays 1126. The display controller(s) 1120 sends information to the display(s) 1126 to be displayed via one or more video processors 1128, which process the information to be displayed into a format suitable for the display(s) 1126. The display(s) 1126 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for controlling communication in a Universal Serial Bus (USB) system, comprising:
receiving variably-sized packets at a first processor having a USB driver;
assembling uniformly-sized packets at the first processor; and
passing the uniformly-sized packets to a second processor for use by applications at an application layer in a protocol stack.

2. The method of claim 1, wherein the first processor and the second processor are integrated into a single integrated circuit.

3. The method of claim 1, wherein receiving the variably-sized packets at the first processor comprises receiving the variably-sized packets at a microprocessor.

4. The method of claim 1, wherein receiving the variably-sized packets at the first processor comprises receiving the variably-sized packets at an audio digital signal processor (ADSP).

5. The method of claim 1, wherein receiving the variably-sized packets at the first processor comprises receiving the variably-sized packets at an intermediate device between a peripheral and a host.

6. The method of claim 1, wherein receiving the variably-sized packets comprises receiving the variably-sized packets at a processor in a peripheral.

7. The method of claim 1, wherein assembling the uniformly-sized packets comprises using a bus frequency and a samples per packet to calculate a size.

8. The method of claim 1, wherein assembling the uniformly-sized packets comprises using a sampling frequency of content.

9. The method of claim 1, wherein assembling the uniformly-sized packets comprises receiving a time stamp from a high resolution timer.

10. A host comprising:
an application processor;
Universal Serial Bus (USB) hardware; and
an audio digital signal processor (ADSP) configured to:
receive variably-sized packets at the ADSP through the USB hardware;
assemble uniformly-sized packets at the ADSP; and
pass the uniformly-sized packets to the application processor for use by applications at an application layer in a protocol stack.

11. A host comprising:
an application processor;
Universal Serial Bus (USB) hardware; and
a system on a chip (SoC) comprising a plurality of processors configured to:
receive variably-sized packets at a first processor;
assemble uniformly-sized packets at the first processor; and
pass the uniformly-sized packets to a second processor for use by applications at an application layer in a protocol stack.

12. The host of claim 11, wherein the first processor comprises a microprocessor.

13. The host of claim 11, wherein the first processor comprises an audio digital signal processor (ADSP).

14. The host of claim 11, wherein the first processor is configured to assemble the uniformly-sized packets by using a bus frequency and a samples per packet to calculate a size.

15. The host of claim 11, wherein the first processor is configured to assemble the uniformly-sized packets by using a sampling frequency of content.

16. The host of claim 11, wherein the first processor is configured to assemble the uniformly-sized packets by receiving a time stamp from a high resolution timer.

17. A method for detecting drift in a Universal Serial Bus (USB) system, comprising:
determining that a fractional sampling rate is used on a USB bus between an audio peripheral and a host;
determining a first fractional remainder associated with the fractional sampling rate over a service interval;
based on the first fractional remainder, calculating a whole number corresponding to a number of intervals required to have no fractional remainder; and
checking drift each whole number of intervals.

18. The method of claim 17, further comprising applying a drift correction based on checking the drift.

19. A processor comprising:
an input; and
a control system configured to:
determine that a fractional sampling rate is used on a USB bus between an audio peripheral and a host;
determine a first fractional remainder associated with the fractional sampling rate over a service interval;
based on the first fractional remainder, calculate a whole number corresponding to a number of intervals required to have no fractional remainder; and
check drift each whole number of intervals.

20. The processor of claim 19 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

21. A method to synthesize a time stamp, comprising:
receiving a run command from a data delivery handler; and
summing an output from a high resolution timer and a computed absolute time stamp.

22. The method of claim 21, further adding drift correction to the summing to synthesize the time stamp.

23. The method of claim 22, further comprising performing in-band drift detection.

24. The method of claim 22, further comprising performing out-of-band drift detection.

25. The method of claim 22, further comprising adding a device drift accumulator output to a local clock drift accumulator output.

26. The method of claim 21, wherein summing comprises summing in a processor in a mobile terminal.

27. The method of claim 21, wherein summing comprises summing in a dongle.

28. A processor comprising:
an audio data buffer; and
a Universal Serial Bus (USB) audio client (UAC) configured to:
receive variably-sized packets;
assemble uniformly-sized packets; and
pass the uniformly-sized packets to a second processor for use by applications at an application layer in a protocol stack.

29. The processor of claim 28 wherein the processor is positioned within a USB peripheral.

30. The processor of claim 28, wherein the processor is positioned in an intermediate device configured to sit between a peripheral and a host.

31. The processor of claim 28, wherein the processor is positioned in a host.

32. The processor of claim 28 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
